(19) United States
(12) Patent Application Publication
(10) Pub. No.: US 2007/0004686 A1
(43) Pub. Date: Jan. 4, 2007

(54) Attractant for apple fruit moth and other insect pests of apple

(76) Inventors: Marie Christina Bengtsson, Lund (SE); Peter Witzgall, Lund (SE); Sverre Kobro, Fagerstrand (NO); Gunnhild Jaastad, Grimo (NO); Jan Lofqvist, (US); Conny Lindhe, Staffanstorp (SE)

Correspondence Address: GAUTHIER & CONNORS, LLP, 225 FRANKLIN STREET, SUITE 2300, BOSTON, MA, 02110, US

(21) Appl. No.: 11/089,374

(22) Filed: Mar. 24, 2005

Related U.S. Application Data
(63) Continuation of application No. PCT/SE03/01440, filed on Sep. 16, 2003.

(30) Foreign Application Priority Data
Sep. 24, 2002 (SE) 0202810-8

(51) Int. Cl. A01N 37/36; A01N 37/02; A01N 31/00

(52) U.S. Cl. 514/159; 514/546; 514/730; 514/739; 514/762

(57) ABSTRACT

The present invention relates to the use of behaviour modifying volatile plant compounds of rowan Sorbus aucuparia and apple Malus domestica for a determination of a population or controlling pest insects on apple, in particular apple fruit moth Argyresthia conjugella Zeller (Lepidoptera, Argyresthiidae) and codling moth Cydia Pomonella L. (Lepidoptera, Tortricidae). The compound 2-phenylethanol, only or in combination with other compounds, in particular anetole, efficiently attracting females and males of apple fruit moth A. conjugella. Other compounds identified from rowan and apple include p-anisaldehyde, )E)-beta-farnesene, farnesol, (Z)3-hexenyl 2-methylbutanoate, linalool and methylsalicylate efficiently attracting apple fruit moth, codling moth and other important pest insects of apple.

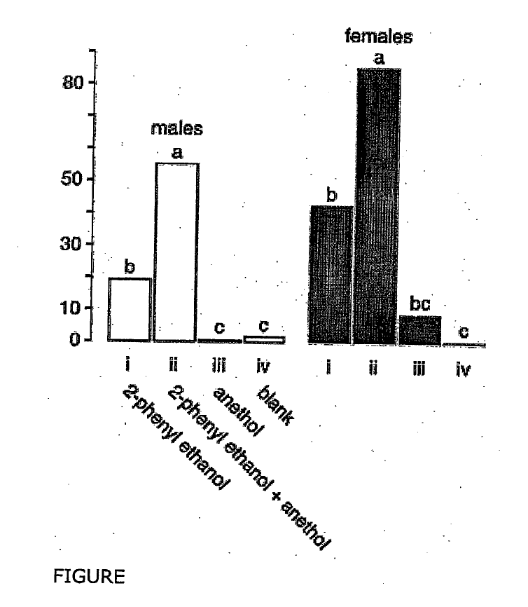

### TECHNICAL FIELD

The objective of the present invention is to obtain an efficient method for controlling apple fruit moth Argyresthia conjugella Zeller (Lepidoptera, Argyresthiidae), codling moth Cydia pomonella L. (Lepidoptera, Tortricidae), and other important insect pests of apple, such as the green budworm moth Hedya nubiferana Haw. and Pandemis heparana D. & S. (Lepidoptera, Tortricidae).

Males and females of many insect species are attracted to their respective host plants prior to mating, which function as sexual rendez-vous sites. This attraction is mediated largely by olfactory cues, i.e. volatile compounds or odours emanating from plants, while visual cues usually play a minor role. After mating, the gravid females use host plant odours to identify suitable sites for egg-laying.

Plant volatile compounds function as bisexual attractants, for both males and females. These compounds can be used to monitor the presence and population density of insect species and to thus determine whether control measures are necessary, and to optimize the time of control measures. For moths, sex pheromones are widely used for monitoring, but sex pheromones attract only males. Attraction of females adds important information, especially as this allows to determine whether the females have already been mated or not.

Plant volatile compounds can also be used to control infestations, by mass trapping of insects in a trap-like enclosure or platform, or in combination with an insecticide as a lure and kill formulation, or by disrupting the host-finding behaviour of the adult moths.

The investigation of compounds responsible for attraction of insects to their host plant usually relies on the identification of compounds released by the respective host plant. For insects feeding on apple, compounds from apple would accordingly be the prime target for behavioural studies. The use of apple compounds for insect control in apple orchards is, however, associated with a most important practical difficulty: apple trees release large amounts of volatiles and sources of artificial apple odour may be outcompeted by the background of natural apple odour.

Insects have frequently adapted to new host plants during phylogenetic development and host-shifts are considered to play an important role in the speciation process. Many insects feeding on apple Malus domestica (Rosaceae) are thus phylogenetically related to species feeding on other plants from the Rosacean family, and are accordingly equipped with the sensory apparatus, i.e. antennal receptors, for plant compounds which are not typical for apple, but for Rosaceaen plants other than apple. Other insect species feed on several Rosacean plants, including apple, and may switch between hosts according to availability.

Certain compounds from Rosacean plants other than apple may therefore have a behavioural effect on apple insects. These non-apple compounds can be used alone or in blend combinations with apple compounds to produce a new, characteristic odour signal. Such signals' are different from the background of natural apple odour and may therefore be more suitable for use in insect monitoring and control.

Compound Names:

2-Phenyl ethanol

Anethole

P-Anisaldehyde

(E,E)-alfa-Farnesene

(E)-beta-Farnesene

Farnesol

Linalool

Methylsalicylate

### BACKGROUND OF THE INVENTION

Importance of new control methods for apple fruit moth Argyresthia conjugella. Apple fruit moth Argyresthia conjugella Zeller (Lepidoptera, Argyresthiidae), is probably the most important pest of apple in Scandinavia (Ahlberg 1927, Fjelddalen 1974). The primary host of A. conjugella is rowan (mountain ash), Sorbus aucuparia. However, flowering and fruitsetting of rowan is fluctuating strongly. Populations of A. conjugella build up in forests during good fruiting years, until every third to fourth year, when too few rowan berries are available for egg-laying (Ahlberg 1927, Sperens 1997 a,b). Females of A. conjugella then invade apple orchards, where the entire crop can be destroyed.

Contamination of fruit and groundwater argues against the use of insecticides. Several insecticides used against apple fruit moth, such as azinphos methyl (Gusathion, Guthion), have been deregulated or will soon be deregulated in many countries (e.g. Koch & Schietinger 1999). This demands the development of new pest control techniques.

Mating disruption by pheromone allows environmentally safe control of codling moth, another most important pest of apple (see below). One main argument against the use of codling moth mating disruption in Scandinavia is that biological control methods are not available against apple fruit moth A. conjugella. Routine sprays are now used to simultaneously control A. conjugella and C. pomonella.

Availability of new, environmentally safe methods will bring ecological fruit growing into reach, and will even reinforce the competitiveness of conventional fruit production in Scandinavia.

Importance of new control methods for codling moth Cydia pomonella Codling moth Cydia pomonella L. (Lepidoptera, Tortricidae) is the key insect pest of pome fruit worldwide. Several insecticides used against it will not be available to fruit farmers in the long run (see above). In addition, codling moth has grown resistant to most insecticides used against it (e.g. Boivin et al. 2001).

The most promising, environmentally safe approach to control codling moth is to use non-toxic, behaviour-modifying chemicals (semiochemicals). Semiochemicals are divided into chemicals which mediate interactions between individuals of the same species (pheromones), and chemicals which mediate interactions between different species (kairomones and allomones).

Pheromone-mediated mating disruption disturbs the mate-finding behaviour of male moths. The mating disruption technique is already commercially used (Thomson et al. 2001). However, this technique is not operative at high population densities (Witzgall et al. 1999). The availability of a method to manipulate, in addition, the behaviour of egg-laying females would be most important.

Under mating disruption, monitoring traps baited with synthetic sex pheromone do not attract males: the background of synthetic pheromone abolishes male orientation to these traps. Females, in comparison with synthetic pheromone lures, release a blend containing several behaviourally active compounds. Males may accordingly still find females, while pheromone trap catch is strongly reduced. It is therefore difficult to judge the efficacy of the mating disruption treatment according to captures in pheromone traps (Witzgall et al. 1999, 2001).

Other Insects Feeding on Apple

When alleviating insecticide use, a number of other species, such as green budworm Hedya nubiferana or other leafroller moths, for example Pandemis heparana, need to be controlled. Females of these species lay eggs close to green apples, and they use volatile compounds to distinguish between their host plant and other non-host plants, or to distinguish between host trees with and without fruit.

Host-Finding in Insects is Guided by Plant Volatiles

There is growing evidence that host-finding in moths is largely guided by secondary plant metabolites (Dethier 1982, Isman 1992, Metcalf & Metcalf 1992, Honda 1995, Schoonhoven et al. 1998). Gravid females make the critical host choice prior to and during oviposition, since newly hatched larvae cannot migrate over long distances. Higher plants release a large variety of volatile compounds, especially from reproductive organs. However, recent studies show that it is only a few “key” compounds which mediate long-range attraction, and that these compounds are perceived by specialized chemoreceptor neurons on the antenna (Anderson et al. 1995, Wibe et al. 1998, Rostellen et al. 2000). In a noctuid moth, Helicoverpa armigera, a synthetic six-component kairomone has been shown to elicit the same behavioral response as its host plant (Hartlieb & Rembold 1996).

Plant Volatiles and Host-Finding in Apple Fruit Moth

Volatile chemicals from rowan are undoubtedly critical for host-finding in A. conjugella. Apple fruit moth is a nocturnal species, attraction to rowan among mixed forest vegetation, and especially discrimination of fruiting and non-fruiting trees cannot be achieved by visual or gustatory cues.

The preferred host of A. conjugella is rowan. The survival rate of A. conjugella on apple is low, and an establishment of populations in orchards has not been reported (Ahlberg 1927). Attraction of A. conjugella to apple, during years when rowan berries are not available, is probably due to the co-occurrence of volatile constituents in rowan and apple. Apple and rowan belong to the the same plant family, Rosaceae, and related plants resemble each other even with respect to secondary metabolism (e.g. Berenbaum & Seigler 1992).

Therefore it has been hypothesized that traps baited with synthetic rowan volatiles should make an excellent tool to intercept migrating females at orchard borders. One particularly important advantage of such an artificial rowan lure is the absence of competing sources of natural rowan volatiles in orchards.

Plant Volatiles and Host-Finding in Codling Moth and Other Species from Apple

As outlined above (“Technical Field”), insects which primarily feed on apple Malus domestics (Rosaceae) may be sensitive to compounds which are typical even for other, closely plants of this family, such as rowan. The inverse is true for apple fruit moth, which obviously is attracted to apple compounds.

Even for species occurring within apple orchards, use of rowan volatiles would be advantageous, as there are no competing' sources of natural rowan volatiles in orchards.

Use of Plant Volatiles in Insect Control

There are three main strategies to use plant volatile compounds for insect control: mass trapping, attract & kill and disruption of host-finding behaviour. These techniques are expected to result in efficient population control if a powerful attractant for egglaying females is available.

The female-produced sex pheromone of apple fruit moth (Jaastad et al. 2002) is not suitable for population control. Female sex pheromones, which effect only male behaviour, are used to control other orchard insects, such as codling moth or Oriental fruit moths either by mating disruption (Rice & Kirsch 1990, Gut & Brunner 1998) or male annihilation (“attracticide”, “attract & kill”) (Charmillot et al. 2000). These insects feed on apple, and a contiguous surface must be treated, including all adjacent orchards.

The main difference between apple fruit moth and other orchard insects is that apple fruit moth does not occur in the orchards prior to mating—mated females migrate from the forests into the orchards. Apple fruit moth eclose and mate in forests. In order to use sex pheromone for population control, one should accordingly treat all forests surrounding the orchards to be protected, which is difficult to achieve in most locations, besides being very costly. Therefore, the sex pheromone of apple fruit moth can only be used in monitoring or warning traps, but not for population control.

In comparison, availability of a strong female attractant enables the use of either mass traps, an attracticide formulation (combination of attractant and insecticide), or disruption of host-finding or egg-laying behaviour. In addition, availability of male and female attractants based on plant volatiles will also increase the reliability of traps used for population monitoring. This is true for all insect species, including all species living within apple orchards.

WO 98/53678 relates to a device and a method for controlling pest insects by applying odour masking compounds, in particular phenolic compounds, in particular naphtalenic compounds, mono-terpenoidal compounds, aliphatic alkenes, and alkynes, as well as ketones and methyl ketones of aliphatic compounds. Among such odour masking compounds methylsalicylate, linalool, and allo-ocimene are mentioned. The substances are thus disclosed as odour masking compounds and not as attracting compounds.

U.S. Pat. No. 6,264,939 relates to novel bisexual attractants for codling moth, which attractants are derivatives of decadienoates. In the description it is shown that mature Bartlett pears contain 77 different volatile compounds, whereby t-anethole is present in 0.06%, and (E,E)-alfa-farnesene is present with 20.53% of a 100% mixture of such volatile compounds while immature pears of the same specie contains 10.6% of (E,E)-alfa-farnesene, and 0.21% of 2-phenylethanol. Further, it is shown that immature apples contains linalool 6.58% (Golden Delicious) respectively 3.94% (Granny Smith), (E,E)-alfa-farnesene 22.5% (Golden Delicious) respectively 12.4% (Granny Smith), methylsalicylate 1.73% (Golden Delicious) respectively 2.34% (Granny Smith), and 2-phenylethanol 0.42% (Golden Delicious) respectively 0.68% (Granny Smith). The paper further shows that only 7 compounds are present both in immature and mature fruit, whereby, however, none of these belongs to the group of esters, viz. alkyl decanoates, decenoates, dodecanoates identified as attractants, aggegants or arrestants for Lepidoptera. Thus there is nothing in the prior art tending that compounds within the scope of the present invention, and defined below, can have a concisive attracting, aggregating or arresting effect.

J. Agric. Food Chem. 49, 3736-3741, (2001), Bengtsson, M. et al, Plant odour analysis of apple, in particular antennal response of codling moth females to apple volatiles during phenological development, whereby nine compounds are detected as being evaporated from branches and leaves while few of these compounds were obtained from green fruit.

STN INTERNATIONAL, file CAPLUS, AN 1998:588604, DN 129:273357, J. Chem. Etiol. 24(9)1491-1497 (1998) shows attraction of Hoplia communis to 2-phenylethanol, evaporated from Rosa spp.

Entomol. Exp. Appl. 102, 145-151 (2002) Hem, A., et al, Induction of volatile emissions from ripening apple fruits infested with Cydia pomonella and the attraction of adult females, describes emission of volatile compounds by influence of larvae of C. pomonella.

U.S. Pat. No. 6,440,406 relates to a composition to atract scarabee bugs, which composition contains phenylacetaldehyde, 2-phenylethanol, limonene, methyl-2-methoxibenzoate, and/or methylsalicylate.

STN INTERNATIONAL, file CAPLUS, AN 1998:588604, DN 129:273357, JP 07242505 A2 describes attractants for Anomala octiescostata, which attractants comprises anethole, geraniol, phenehtyl propionate, benzaldehyde, phenylacetaldehyde, whereby the later two are present in an extract of dandelions.

### DESCRIPTION OF THE PRESENT INVENTION

Comparative chemical analysis of the volatile compounds released from rowan Sorbus aucuparia (Rosaceae) and apple Malus domestica (Rosaceae) by gas chromatography and mass spectrometry showed the co-occurrence of many volatiles in rowan and apple. Several compounds were released in large amounts from rowan, but only in trace amounts in apple.

In particular the invention relates to a formulation to be used in the control or monitoring of insects of the group Argyresthia conjugella, Cydia pomonella, Hedya nubiferana och Pandemis heparana, whereby the formulation contains one or more volatile plant compounds found in wild rowan Sorbus aucuparia or apple Malus domestica selected from the group consisting of 2-phenyl ethanol, anethole, p-anisaldehyde, benzyl alcohol, beta-bourbonene, copaene, beta-cubebene, (E)-beta-farnesene, farnesol, cis-jasmone, limonene, cis-beta-ocimene, beta-phellandrene, phenylacetaldehyde, (Z)3-hexenyl 2-methylbutanoate, linalool, methyl salicylate, beta-caryophyllene, 4,8-dimethyl-1,3,(E)7-nonatriene, (E,E)-alfa-farnesene, germacrene D, and trans-beta-ocimene.

A preferred embodiment of the invention consists in a formulation wherein one or more of the volatile plant compounds is selected from the grooup consisting of anethole, p-anisaldehyde, benzyl alcohol, beta-bourbonene, copaene, beta-cubebene, (E)-beta-farnesene, farnesol, cis-jasmone, limonene, cis-beta-ocimene, beta-fellandrene, phenylacetaldehyde and 2-phenylethanol.

Another preferred embodiment of the invention consists in a formulation wherein one or more of the volatile plant compounds is selected from the group consisting of beta-caryofyllene, 4,8-dimethyl-1,3(E)7-nonatriene, (E,E)-alfa-farnesene, germacrene D, linalool, trans-beta-ocimene, and methylsalicylate.

Another preferred embodiment of the invention consists in a formulation wherein one or more of the volatile plant compounds is selected from the grooup consisting of decanal, (Z)3-hexenyl butanoate, (Z)3-hexenyl-2-metylbutanoate, nonanal.

A further preferred embodiment of the invention consists in a formulation wherein one or more of the volatile plant compounds is selected from the grooup consisting of 2-phenylethanol, anethole, p-anisaldehyde, (E,E)-alfa-farnesene, (E)-beta-farnesene, farnesol, linalool and methylsalicylate.

Another preferred embodiment of the invention relates to a formulation wherein 2-phenylethanol is included in the formulation.

Another preferred embodiment of the invention relates to a formulation wherein anethole is included in the formulation.

A further preferred embodiment of the invention relates to a formulation wherein 2-phenylethanol and anethole are included in the formulation, preferably in a weight ratio of 0.8-1.2:1, more preferably 1:1.

Another preferred embodiment of the invention relates to a formulation wherein methylsalicylate and (E,E)-alfa-farnesene are included in the formulation.

Another preferred embodiment of the invention relates to a formulation wherein farnesol and (E)-beta-farnesene are included in the formulation.

A further preferred embodiment of the invention relates to a formulation wherein p-anisaldehyde and (Z)3-hexenyl-2-methylbutanoate are included in the formulation. är inkluderade i formuleringen.

Another preferred embodiment of the invention relates to a formulation wherein anethole and (Z)3-hexenyl-2-methylbutanoate are included in the formulation.

Another preferred embodiment of the invention relates to a formulation wherein (E)-beta-faresene and (Z)3-hexenyl-2-metylbutanoate are included in the formulation.

A further preferred embodiment of the invention relates to a formulation wherein cis-jasmone and (Z)3-hexenyl-2-methylbutanoate är inkluderade i formuleringen.

Another preferred embodiment of the invention relates to a formulation wherein farnesole and (Z)3-hexenyl-2-methylbutanoate are included in the formulation.

A further aspect of the invention relates to a method for controlling or monitoring insect infestations of fruit orchards by the insects of the group Argyresthia conjugella, Cydia pomonella, Hedya nubiferana och Pandemis heparana, using volatile plant compounds from rowan Sorbus aucuparia and/or apple Malus domestica serving as an attractant, aggregating agent, arrestant or ovulation stimulation agent, whereby an attracting amount of a composition containing an attractant selected from the group consisting of 2-phenylethanol, anethole, p-anisaldehyde, benzyl alcohol, beta-bourbonene, copaene, beta-cubehene, (E)-beta-farnesene, farnesol, cis-jasmone, limonene, cis-beta-ocimene, beta-fellandrene, phenylacetaldehyde, (Z)3-hexenyl 2-methylbutanoate, linalool, methylsalicylate, beta-caryofyllene, 4,8-dimethyl-1,3-(E)7-nonatriene, (E,E)-alfa-farnesene, germacrene D, and trans-beta-ocimene is applied at fruit trees or is placed in a trap in connection to or on fruit trees where the adult insect or larvae infestation is to be onitored or control of the infestation is to be achieved.

A preferred embodiment of the method of the invention relates to the use of a formulation for controlling or monitoring a fruit tree infestation by apple fruit moth Argyresthia conjugella.

A preferred embodiment of the method of the invention relates to the use of a formulation for controlling or monitoring a fruit tree infestation by codling moth Cydia pomonella.

A further preferred embodiment of the method comprises use of a formulation which further encompasses an insecticide or a sexual pheromone.

The most important compounds predominantly found in wild rowan and several rowan clones were: anethole, p-anisaldehyde, benzyl alcohol, beta-bourbonene, copaene, beta-cubebene, (E)-beta-farnesene, farnesol, ds-jasmone, limonene, cisbeta-ocimene, beta-phellandrene, phenylacetaldehyde and 2-phenyl ethanol.

Compounds found in significant amounts, but different proportions, in both species were: beta-caryophyllene, 4,8-dimethyl-1,3,(E)7-nonatriene, (E,E)-alfa-farnesene, germacrene D, linalool, trans-beta-ocimene and methyl salicylate.

Compounds found in apple only were: decanal, (Z)3-hexenyl butanoate, (Z)3-hexenyl 2-methylbutanoate, nonanal.

The compounds eliciting a strong response from antennae of female apple fruit moth and codling moth were then all tested in field traps for attraction of insects. Compounds were applied at a standard dose of 10 mg on red rubber septa, the septa were mounted in Tetra traps with sticky bottoms (Arm et al. 1979).

Attraction of Apple Fruit Moth

Several single compounds were found to attract apple fruit moth females and males in numbers significantly different from blank: anethole, p-anisaldehyde, linalool, methyl salicylate and 2-phenyl ethanol. The single most attractive compound was 2-phenyl ethanol (Figure), followed by anethole and methyl salicylate.

Subsequently, several two-component blends were tested, and the blends showing a synergistic effect (stronger than an additive effect when combing compounds) were 2-phenyl ethanol plus anethole (Figure), and methylsalicylate plus (E,E)-alfa-farnesene.

Furthermore, 2-phenyl ethanol was tested in a series of 2-component blends, including all compounds which had shown some attractiveness by themselves. A blend of 2phenyl ethanol plus anethole was the most attractive for apple fruit moth males and females, and was more attractive than 2-phenyl ethanol alone (Figure), or any other compound or compound blend tested. Anethole by itself was only a weak attractant and attracted less insects than 2-phenyl ethanol.

2-phenyl ethanol is an attractant for both males and females of apple fruit moth Argyresthia conjugella. Its attractivity can be augmented by blending it with anethole. This blend was even rather species-specific, other insects were not attracted in significant numbers. Both sexes of Argyresthia conjugella were attracted. Attraction of females is of importance for monitoring the migration of mated females into orchards. Attraction of females enables population control by mass-trapping, by an attracticide formulation, or by disruption of mating and oviposition behaviour.

The activity of this blend can likely be augmented by adding further compounds identified from rowan or apple, such as methylsalicylate plus (E,E)-alfa-farnesene. The combination of compounds found in rowan and apple creates a new, characteristic odour signal, which is different the background odour in apple orchards.

Attraction of Codling Moth

Codling moth males were attracted in significant numbers to traps baited with 10 mg of the rowan volatiles p-anisaldehyde, anethole, (E)-beta-farnesene, cis-jasmone and farnesol, and to the apple volatile (Z)3-hexenyl 2-methylbutanoate. In a wind tunnel experiment, a blend of farnesol and (E)-beta-farnesene released at 10 ng/min attracted within 2 min 35% of the males tested to the source (N=60).

Attraction of Insects from Apple

The green budworm moth Hedya nubiferana and Pandemis heparana were attracted to blends containing (E)-beta-farnesene plus (E,E)-alfa-farnesene, and (E)-betafarnesene plus cis-jasmone.

Application of the Present Invention

The described compounds or compound blends can be used in any kind of insect trap or system for confusing or disrupting behaviours, controlling, collecting, attracting, killing or monitoring insects. The compounds or blends can be included in other formulations to combine with effects of other compounds. Other insects than Argyresthia conjugella, Cydia pomonella, Hedya nubiferana and Pandemis heparana could be attracted, confused or even repelled by the described compounds or blend, giving the invention complete utility.

Related Disclosures

Both compounds, 2-phenyl ethanol and anethole are widely distributed in the plant and animal kingdom. 2-Phenyl ethanol is an essential aroma and flavour component in fruit, tea, wine, cheese, bread and beer, and is also produced by several insects. Anethole is a common aroma component, which has also antifungal and insecticidal activity.

The most important publications on the occurrence and biological activity of 2phenyl ethanol and anethole in insects are listed in Appendix I.

Attraction of Argyresthia conjugella to 2-phenyl ethanol has not been reported, and the blend of 2-phenyl ethanol and anethole has not been described to be attractive for any other species. During our field trapping experiment, no other insects were attracted in significant numbers to 2-phenyl ethanol or the blend of 2-phenyl ethanol and anethole (1:1 w/w), 2-phenyl ethanol is species-specific under the conditions tested (region, time of season).

Attraction of codling moth to the compounds mentioned above has not been reported.

Appendix I

2-Fenyletanol

2-Phenylethanol (in Combination with N-Valeric Acid) Attracts Onion and Seed-Corn File
Ishikawa Y. Matsumoto Y, Tsutsumi M, Mitsui Y (1984) Experimental field trapping of the onion and seed-corn flies, Hylemya antiqua and H. platura (Diptera: Anthomyiidae), using 2-phenylethanol for population estimation. Appl Entomol Zool 19, 75-81.
Ishikawa Y, Matsumoto Y, Tsutsumi M, Mitsui Y (1984) Mixture of 2-phenylethanol and n-valeric acid, a new attractant for the onion and seed-corn flies, Hylemya antiqua and H. platura (Diptera: Anthomyiidae). Appl Entomol Zool 19, 448-455.
   2-Phenylethanol is a Male-Produced Sex or Aggregation Pheromone in Pheromone in Nitidulid Beetles and Noctuid Moths
Jacobson M, Adler V E, Kishaba A M, Priesner E (1976) 2-Phenylethanol, a presumed sexual stimulant produced by the male cabbage looper moth, Trichoplusia ni. Experientia 32, 964-966.
Bartelt R J, Carlson D G, Vetter R S, Baker T C (1993) Male-produced aggregation pheromone of Carpophilus mutilatus (Coleoptera: Nitidulidae). J Chem Ecol 19, 107-118.
Birch M C, Poppy G M (1990) Scents and reversible scent structures of male moths. Ann Rev Entomol 35, 25-28
   2-Phenyl Ethanol Attracts Ladybird Beetles, Lacewings, Nitidulid Beetles, Noctuid Moths, Scarabid Beetles, Stored-Product Beetles
Imai T, Maekawa M, Tsuchiya S, Fujimori T (1998) Field attraction of Hoplia communis to 2-phenylethanol, a major volatile component from host flowers, Rosa spp. J Chem Ecol 24, 1491-1497.
Haynes K F, Zhao J Z, Latif A (1991) Identification of floral compounds from Abelia grandiflora that stimulate upwind flight in cabbage looper moths. J Chem Ecol 17, 637-646.
Honda K, Omura H, Hayashi N (1998) Identification of floral volatiles from Ligustrum japonicum that stimulate flower-visiting by cabbage butterfly, Pieris rapae. J Chem Ecol 24, 2167-2180.
Pierce A M, Pierce H D, Borden J H, Oehlschlager A C (1991) Fungal volatiles: semiochemicals for stored-product beetles (Coleoptera: Cucujidae). J Chem Ecol 17, 581-597. Zhu J W, Cosse A A, Obrycki J J, Boo K S, Baker T C (1999) Olfactory reactions of the twelve-spotted lady beetle, Coleomegilla maculata and the green lacewing, Chrysoperla carnea to semiochemicals released from their prey and host plant: electroantennogram and behavioral responses. J Chem Ecol 25, 1163-1177.
Zilkowski B W, Bartelt R J, Blumberg D, James D G, Weaver D K (1999) Identification of host-related volatiles attractive to pineapple beetle Carpophilus humeralis. J Chem Ecol 25, 229-252
   2-Phenylethanol Attracts and Repels House Flies
Adler V E, Jacobson M (1982) Evaluation of selected natural and synthetic products as house fly repellents. J Environm Sci Health 17A 5, 667-673.
Chapman J W, Knapp J J, Howse P E, Goulson D (1998) An evaluation of (Z)-9-tricosene and food odours for attracting house flies, Musca domestica, to baited targets in deep-pit poultry units. Entomol Exp Appl 89, 183-192.
   2-Phenyl Ethanol is Produced by Various Ants, Bark Beetles, Bugs, Butterflies, Caddisflies and Moths, Whereby the Behavioural Effect is Still Unclear
Aldrich J R, Carroll S P, Oliver J E, Lusby W R, Rudmann A A, Waters R M (1990) Exocrine secretions of scentless plant bugs: Jadera, Boisea and Niesthrea species (Hemiptera: Heteroptera: Rhopalidae). Biochem Systemat Ecol 18, 369-376.
Ansteeg O, Dettner K (1991) Chemistry and possible biological significance of secretions from a gland discharging at the 5th abdominal sternit of adult caddisflies (Trichoptera). Entomol Gen 15, 303-312.
Birgersson G, Schlyter F, Lofqvist J, Bergstrom G (1984) Quantitative variation of pheromone components in the spruce bark beetle Ips typographus from different attack phases. J Chem Ecol 10, 1029-1055.
Cruz L L, Morgan E D, Ondarza R N, Lopez L C (1995) Brindley's gland exocrine products of Triatoma infestans. Med Vet Entomol 9, 403-406.
Gough A J E, Games D E, Staddon B W, Olagbemiro T O (1985) Male produced volatiles from coreid bug Leptoglossus australis (Heteroptera). Z f Naturforsch 40 c: 142-144.
Ivarsson P, Birgersson G (1995) Regulation and biosynthesis of pheromone components in the double spined bark beetle Ips duplicatus (Coleoptera: Scolytidae). J Ins Physiol 41, 843-849
Jacquin E, Nagnan P, Frerot B (1991) Identification of hairpencil secretion from male Mamestra brassicae (L.) (Lepidoptera: Noctuidae) and electroantennogram studies. J Chem Ecol 17, 239-246
James D G, Moore C J, Aldrich J R (1994) Identification, synthesis, and bioactivity of a male-produced aggregation pheromone in assassin bug, Pristhesancus plagipennis (Hemiptera: Reduviidae). J Chem Ecol 20, 3281-3295
Lloyd H A, Blum M S, Duffield R M (1975) Chemistry of the male mandibular gland secretion of the ant, Camponotus clarithorax. Insect Biochem 5, 489-494.
Omura H, Honda K, Hayashi N (2001) Identification of odoriferous compounds from adults of a swallowtail butterfly, Papilio machaon (Lepidoptera: Papilionidae). Z f Naturforsch 56 c, 1126-1134.
Pureswaran D S, Gries R, Borden J H, Pierce H D (2000) Dynamics of pheromone production and communication in the mountain pine beetle, Dendroctonus ponderosae Hopkins, and the pine engraver, Ips pini (Say) (Coleoptera: Scolytidae). Chemoecol 10, 153-168.
Renwick J A A, Pitman G B, Vite J P (1976) 2-Phenylethanol isolated from bark beetles. Naturwissenschaften 6, 198
Wood W F, Palmer T M, Stanton M L (2002) A comparison of volatiles in mandibular glands from three Crematogaster ant symblonts of the whistling thorn acacia. Blochem Systemat Ecol 30, 217-222.
Zhang Q H, Birgersson G, Schlyter F, Chen G F (2000) Pheromone components in the larch bark beetle, Ips cembrae, from China: Quantitative variation among attack phases and individuals. J Chem Ecol 26, 841-858.
   2-Phenyl Ethanol is a Yeast Metabolite Attractive to Bark Beetles; Ips pini Produces 2-Phenyl Ethanol when Boring into Fresh Pine
Brand J M, Schultz J, Barras S J, Edson L J, Payne T L, Hedden R L (1977) Bark-beetle pheromones: enhancement of Dendroctonus frontalis (Coleoptera: Scolytidae) aggregation pheromone by yeast metabolites in laboratory bioassays. J Chem Ecol 3, 657-666.
Gries G, Smirle M J, Leufven A, _Miller D R, Borden J H, Whitney H S (1990) Conversion of phenylalanine to toluene and 2-phenylethanol by the pine engraver Ips pini (Say) (Coleoptera, Scolytidae). Experientia 46, 329-331.
   Anetol
   Anethole Attracts Scarab Beetles, Hymenopterans, Lovebugs
Allsopp P G (1992) Volatile compounds as attractants for Campsomeris tasmaniensis (Saussure) (Hymenoptera: Scoliidae). Austral Entomol Mag 19, 107-110.
Cherry R (1998) Attraction of the lovebug, Plecia nearctica (Diptera: Bibionidae) to anethole. Florida-Entomol 81, 559-562.
Cherry R H, Klein M G, Leal W W (1996) Attraction of adult Anomala marginata (Coleoptera: Scarabaeidae) to anethole. J Agr Entomol 13, 359-364.
Crocker R L, Klein M G, Wel X, Nailon W T (1999) Attraction of Phyllophaga congrua, Phyllophaga crassissima, Phyllophaga crinita, and Cyclocephala lurida (Coleoptera: Scarabaeidae) adults to selected volatile compounds. Southwestern Entomol 24, 315-320.
   (E)-Beta-Farnesen
   (E)-Beta-Farnesene Attracts Carabids, Ladybirds, Parasitoids, Thrips
Al-Abassi S, Birkett M A, Pettersson J, Pickett J A, Wadhams L J, Woodcock C M (2000) Response of the seven-spot ladybird to an aphid alarm pheromone and an alarm pheromone inhibitor is mediated by paired olfactory cells. J chem Ecol 26, 1765-1771
Du Y, Poppy G M, Powell W, Pickett J A, Wadhams L J, Woodcock C M (1998) Identification of semiochemicals released during aphid feeding that attract parasitoid Aphidius ervi. J chem Ecol 24, 1355-1368
Kielty J P, Allen W L J, Underwood N, Eastwood E A (1996) Behavioral responses of three species of ground beetle (Coleoptera: Carabidae) to olfactory cues associated with prey and habitat. J Ins Beh 9, 237-250
Koschier E H, de-Kogel W J, Visser J H (2000) Assessing the attractiveness of volatile plant compounds to western flower thrips Frankliniella occidentalis. J chem Ecol 26, 2643-2655
Manjunatha M, Pickett J A, Wadhams L J, Nazzi F (1998) Response of western flower thrips, Frankliniella occidentalls and its predator Amblyselus cucumeris to chrysanthemum volatiles in olfactometer and greenhouse trials. Ins Sci Appl 18, 139-144
   (E)-Beta-Farnesene is an Oviposition Stimulant in Seed Wasps
Kamm J A, Buttery R G (1986) Ovipositional behaviour of the alfalfa seed chalcid (Hymenoptera: Eurytomidae) in response to volatile components of alfalfa. Environm Entomol 15, 388-391.
   Farnesol

Farnesyl pyrophosphate, the metabolically active form of farnesol, is a key precursor in the synthesis of cholesterol, carotenoids, steroid hormones, bile acids and other molecules involved in cellular growth and metabolism.

Farnesol Attracts Fruit Flies

Nigg H N, Mallory L L, Simpson S E, Callaham S B, Toth J P, Fraser S, Klim M, Nagy S, Nation J L, Attaway J A (1994) Caribbean fruit fly, Anastrepha suspensa (Loew), attraction to host fruit and host kairomones. J chem Ecol 20, 727-743
   Farnesol is Sex Pheromone Component in Click Beetles, Aggregation Pheromone Component in Bugs, Hairpencil Component in Butterflies
James D G, Mori K, Aldrich J R, Oliver J E (1994) Flight-mediated attraction of Biprorulus bibax Breddin (Hemiptera: Pentatomidae) to natural and synthetic aggregation pheromone. J chem Ecology 20, 71-80
James D G, Heffer R, Amaike M (1996) Field attraction of Biprorulus bibax Breddin (Hemiptera: Pentatomidae) to synthetic aggregation pheromone and (E)-2-hexenal, a pentatomid defense chemical. J chem Ecol 22, 1697-1708.
Nishida R, Schulz S, Kim C S, Fukami H, Kuwahara Y, Honda K, Hayashi N (1996) Male sex pheromone of a giant danaine butterfly, Idea leuconoe. J chemi Ecol 22, 949-972
Yatsynin V G, Ruba nova E V, Okhrimenko N V (1996) Identification of female-produced sex pheromones and their geographical differences in pheromone gland extract composition from click beetles (Col., Elateridae). J appl Entomol 120, 463-466
   Farnesol Disrupts Foraging in Ants, Deters Oviposition in Corn Borer
Shorey H H, Gaston L K, Gerber R G, Phillips P A, Wood D L (1992) Disruption of foraging by Argentine ants, Iridomyrmex humilis (MAYR) (Hymenoptera: Formicidae), in citrus trees through the use of semiochemicals and related chemicals. J chem Ecology 18, 2131-2142
Binder B F, Robbins J C, Wilson R L (1995) Chemically mediated ovipositional behaviors of the European corn borer, Ostrinia nubilalis (Lepidoptera: Pyralidae). J chem Ecol 21, 1315-1327

### REFERENCES

Ahlberg O (1927) Rönnbärsmalen, Argyresthia conjugella Zell. En redogörelse för undersökningar åren 1921-1926. Meddel. Nr. 324 från Centralanstalten för försöksväsendet på jordbruksområdet, Lantbruksentomologiska avdelningen, Stockholm.
Anderson P, Hansson B S, Löfqvist J (1995) Plant-odour-specific receptor neurones on the antennae of female and male Spodoptera littoralis. Physiol Entomol 20, 189-198
Arn, H., Rauscher, S., and Schmid, A. 1979. Sex attractant formulations and traps for the grape moth Eupoecilia ambiguella Hb. Mitt. Schweiz. Entomol. Ges. 52:49-55.
Bengtsson M, Bäckman A-C, Liblikas I, Ramirez M I, Borg-Karlson A-K, Ansebo L, Anderson P, Löfqvist J, Witzgall P (2001) Plant odor analysis of apple: antennal response of codling moth females to apple volatiles during phenological development. J Agr Food Chem 49, 3736-3741
Berenbaum M, Seigler D (1992) Biochemicals: engineering problems for natural selection, pp. 89-121 in Roitberg B D, Isman M B (eds.) Insect chemical ecology. Chapman & Hall, New York
Bolvin T, D′-Hieres C C, Bouvier J-C, Beslay D, Sauphanor B (2001) Pleiotropy of Insecticide resistance in the codling moth, Cydia pomonella. Entomol exp appl 99, 381-386.
Charmillot P-J, Hofer D, Pasquier D (2000) Attract and kill: a new method for control of the codling moth Cydia pomonella. Ent exp appl 94, 211-216
Dethier V G (1982) Mechanism of host plant recognition. Entomol exp appl 31, 49-56
Fjelddalen J (1974) Organization of plant protection in Norway and research orientation. Bull Org Eur Med Plant Prot 4 (3), 241-249
Gut, L. J.; Brunner, J. F. Pheromone-based management of the codling moth (Lepidoptera: Tortricidae) in Washington apple orchards. J. Appl. Ent. 1998, 15, 387-405.
Hartlieb E, Rembold H (1996) Behavioral response of female Helicoverpa (Heliothis) armigera Hb. (Lep.: Noctuidae) moths to syntehtic pigeonpea (Cajanus cajan L.) kalromone. J Chem Ecol 22, 821-837
Honda K (1995) Chemical basis of differential oviposition by lepidopterous insects. Arch Ins Biochem Physiol 30, 1-23
Isman M B (1992) A physiological perspective, pp. 156-176 in Roitberg B D, Isman M B (eds.) Insect chemical ecology: an evolutionary approach. Chapman & Hall, New York
Jaastad G, Anderson P, Bengtsson M, Kobro S, Knudsen G, Witzgall P (2002) Sex pheromone of apple fruit moth Argyresthia conjugella (Lepidoptera, Argyresthiidae). J Agric Forest Entomol 4, 1-4
Koch H K, Schietinger R (1999) Abstandsauflagen und Zulassung von Pflanzenschutzmittein im Obstbau. Obstbau 24(7), 362-365
Metcalf R L, Metcalf E R (1992) Plant kairomones in insect ecology and control. Chapmann & Hall, New York
Rice R E, Kirsch P (1990) Mating disruption of Oriental fruit moth in the United States, in: Behavior-modifying chemicals for insect management: applications of pheromones and other attractants, (Ridgway R L, Silverstein R M, Inscoe M N, eds.), pp. 193-211. Marcel Dekker, New York.
Røstelien T, Borg-Karlson A-K, Fäldt J, Jacobsson U, Mustaparta H (2000) The plant sesquiterpene germacrene D specificially activates a major type of antennal receptor neuron of the tobacco budworm moth Heliothes virescens. Chem Senses 25, 141-148
Schoonhoven L M, Jermy T, van Loon J J A (1998) Insect-plant biology: from physiology to evolution. Chapman & Hall, London.
Sperens U (1997a) Long-term variation in, and effects of fertiliser addition on, flower, fruit and seed production In the tree Sorbus aucuparia (Rosaceae). Ecography 20, 521-534
Sperens U (1997b) Fruit production in Sorbus aucuparia L. (Rosaceae) and pre-dispersal seed predation by the apple fruit moth (Argyresthia conjugella Zell.). Oecologia 110, 368-373
Thomson D, Brunner J, Gut L, Judd G, Knight A (2001) Ten years Implementing codling moth mating disruption in the orchards of Washington and British Columbia: starting right and managing for success! IOBC wprs Bulletin 24(2), 23-30
Wibe A, Borg-Karlson A-K, Persson M, Norin T, Mustaparta H (1998) Enantiomeric composition of monoterpene hydrocarbons in some conifers and receptor neuron discrimination of a-pinene and limonene enantiomers in the pine weevil, Hyloblus abietis. J chem Ecol 24, 273-287
Witzgall P, Bäckman A-C, Svensson M, Koch U T, Rama F, El-Sayed A, Strandh M, Brauchli J, Arm H, Bengtsson M, Löfqvist J (1999) Behavioural observations of codling moth, Cydia pomonella, in orchards permeated with synthetic pheromone. BioControl 44, 211-237

Witzgall P, Bengtsson M, Rauscher S, Liblikas I, Bäckman A-C, Coracini M, Anderson P, Löfqvist J (2001) Identification of further sex pheromone synergists in the codling moth, Cydia pomonella. Ent exp appl 101, 131-141

1. A formulation to be used for controlling or monitoring insects of the group Argyresthia conjugella, Cydia pomonella, Hedya nubiferana and Pandemis heparana, wherein the formulation contains one or more volatile plant compounds of rowan Sorbus aucuparia or apple Malus domestica selected from the group consisting of 2-phenylethanol, anethole, p-anisaldehyde, (E,E)-alfa-farnesene, (E)-beta-farnesene, farnesol, linalool, and methylsalicylate.

2. A formulation according to claim 1, wherein one or more of the volatile plant compounds is selected from the group consisting of anethole, p-anisaldehyde, (E)-beta-farnesene, farnesol, and 2-phenylethanol.

3. A formulation according to claim 1, wherein one or more of the volatile plant compounds is selected from the group consisting of (E,E)-alfa-farnesene, linalool, and methylsalicyiate.

4. A formulation according to claim 1, wherein 2-phenylethanol is included in formulation.

5. A formulation according to claim 1, wherein anethole is included in formulation.

6. A formulation according to claim 1, wherein 2-phenylethanol are included in formulation.

7. A formulation according to claim 8, wherein 2-phenylethanol and anethole are present in a weight ratio of 0.8-1.2, preferably 1:1.

8. A formulation according to claim 1, wherein methylsalicylate and (E,E)-alfa-farnesene are included in formulation.

9. A formulation according to claim 1, wherein farnesol and (E)-beta-farnesene are included in formulation.

10. A method for controlling or monitoring insect infestations of fruit orchards by the insects of the group Argyresthia conjugella, Cydia pomonella, Hedya nubiferana och Pandemis heparana, using volatile plant compounds from rowan Sorbus aucuparia and/or apple Malus domestica serving as an attractant, aggregating agent, arrestant or ovulation stimulation agent, whereby an attracting amount of a composition containing an attractant selected from the group consisting of 2-phenylethanol, anethole, p-anisaldehyde, (E,E)-alfa-farnesene, (E)-beta-farnesene, farnesol, linalool, and methylsalicylate is applied at fruit trees or is placed in a trap in connection to or on fruit trees where the adult insect or larvae infestation is to be onitored or control of the infestation is to be achieved.

11. A method according to claim 10, for controlling or monitoring fruit orchard infestation by apple fruit moth Argyresthia conjugella.

12. A method according to claim 10, for controlling or monitoring fruit orchard infestation by codling moth Cydia pomonella.

13. A method according to claim 10, wherein 2-phenylethanol is included in formulation.

14. A method according to claim 10, wherein anethole is included in formulation.

15. A method according to claim 10, wherein 2-phenylethanol and anethole are included in formulation.

16. A method according to claim 10, wherein 2-phenylethanol and anethole are present in a weight ratio of 0.8-1.2, preferably 1:1.

17. A method according to claim 12, wherein the formulation further comprises an insecticide or a sexual pheromone.

18. (canceled)

19. (canceled)

20. (canceled)
